(19) United States
(12) Patent Application Publication
(10) Pub. No.: US 2017/0201803 A1
(43) Pub. Date: Jul. 13, 2017

(54) EXPLICIT AND IMPLICIT TV AND MOVIE VIEWING AVAILABILITY REMINDERS

(71) Applicant: Google Inc., Mountain View, CA (US)

(72) Inventors: Jonathan Wald, New York, NY (US); Vincent Dureau, San Francisco, CA (US); Salil Pandit, Palo Alto, CA (US); Stephen Lau, Oakland, CA (US)

(21) Appl. No.: 14/994,690

(22) Filed: Jan. 13, 2016

(51) Int. Cl. H04N 21/488; H04N 21/466; H04N 21/435; H04N 21/262; H04N 21/482; H04N 21/258; H04N 21/458

(52) U.S. Cl. CPC H04N 21/4882; H04N 21/25891; H04N 21/4667; H04N 21/458; H04N 21/262; H04N 21/4828; H04N 21/435

(57) ABSTRACT

In one general aspect, a method can include determining, by a computer system, that a user is interested in receiving reminders about particular content, identifying, by the computer system, a particular entity from a plurality of entities, the particular entity being associated with the particular content and including criteria for use in creating a reminder to the user about availability of the particular content, automatically creating the reminder for the user based on the criteria, and scheduling the reminder for activation on a computing device when the computing device is determined to be in proximity to a physical location that includes a device that provides the particular content to the user.

### TECHNICAL FIELD

This description generally relates to managing reminders for the availability of television and movie content.

### BACKGROUND

A user or customer can interact with a variety of application for managing television (TV) and movie content. For example, a user can put movies that the user is interested in seeing in a watch list. In another example, an application can allow a user to set up reminders when new episodes of their favorite TV shows will be available for viewing (when the episodes will air). The reminders can require explicit management by the user. For example, the user may need to sign up for the reminders or for a service that allows the user to create and manage the reminders or the watch list. In many cases, the user may have little to no control over the type of reminder or how the reminder may be provided to the user (e.g., email message vs. Short Message Service (SMS) message). In some cases, a user may want to further personalize the reminder for their specific interests and needs.

### SUMMARY

In one general aspect, a method can include determining, by a computer system, that a user is interested in receiving reminders about particular content, identifying, by the computer system, a particular entity from a plurality of entities, the particular entity being associated with the particular content and including criteria for use in creating a reminder to the user about availability of the particular content, automatically creating the reminder for the user based on the criteria, and scheduling the reminder for activation on a computing device when the computing device is determined to be in proximity to a physical location that includes a device that provides the particular content to the user.

Implementations can include one or more of the following features, alone or in combination with one or more other features. For example, determining that the user is interested in receiving reminders about particular content can include identifying an intrinsic interest of the user in the particular content. The intrinsic interest of the user in the particular content can be based on one or more search terms entered by the user in a web browser user interface (UI). Determining that the user is interested in receiving reminders about particular content can include determining that the user manually defined one or more contexts in which to create the reminder. The criteria for use in automatically creating a reminder to the user about availability of the particular content can include at least one of a time, a time window, timeframe, and a repeat interval. The particular content can be one of a movie, a TV show, a TV episode, a TV season, a streaming media video clip, a video clip pertaining to a particular TV show, or a video clip pertaining to a particular movie. In another general aspect, a computing system can include a content manager including a data model and a content reminder module. The data model can include a plurality of entities. Each entity included in the plurality of entities can include criteria for use in creating reminders associated with content. The computing system can include a repository including the content. The content manager can be configured to associate a particular content included in the content with at least one particular entity included in the plurality of entities and determine that a user is interested in receiving at least one reminder about availability of the particular content. The content reminder module can be configured to automatically create a reminder for the user based on the criteria, and automatically schedule the reminder for activation on a computing device when the computing device is determined to be in proximity to a physical location that includes a device that provides the particular content to the user.

Implementations can include one or more of the following features, alone or in combination with one or more other features. For example, the content manager can further include a reminder provider module configured to provide a user experience on the computing device for receiving and engaging with the at least one reminder about the availability of the particular content. The at least one particular entity can include a context for reminder trigger specifying the physical location. The content manager can further include an offer availability type that specifies at least one platform for delivery of the particular content. The at least one particular entity can include a type of user interest indicating that the particular content associated with the particular entity is either of implicit interest to the user or of explicit interest to the user. The particular content can be one of a movie, a TV show, a TV episode, a TV season, a streaming media video clip, a video clip pertaining to a particular TV show, or a video clip pertaining to a particular movie. The content manager can interface with at least one of a search engine, a voice-based assistant, and a calendar application.

In another general aspect, a method for managing content can include receiving, at a first time and by a computing device executing a search engine application, one or more search terms indicative of particular content of interest to a user, identifying additional content related to the particular content based on the one or more search terms, determining that the additional content is available for access by the user at a second time later than the first time, providing, to a computer system, information indicative of an interest of the user to receive reminders about the particular content, the computer system creating a reminder for the user based on the one or more search terms being indicative of the particular content of interest to the user and based on the user not accessing the additional content at the first time, the reminder being scheduled to trigger at the second time, receiving, by the computer device, the reminder indicating that the additional content related to the particular content is available for access by the user at the second time, and providing, by the computing device, a user experience for engaging with the reminder when the reminder triggers at the second time.

Implementations can include one or more of the following features, alone or in combination with one or more other features. For example, receiving, by the computer device and at the second time, the reminder indicating that the additional content related to the particular content is available for access by the user can include receiving the reminder by at least one of a search engine, a voice-based assistant, and a calendar application. The content can be one of a movie, a TV show, a TV episode, a TV season, a streaming media video clip, a video clip pertaining to a particular TV show, or a video clip pertaining to a particular movie. The reminder can further include information relevant to the user when accessing the available content. The user experience for engaging with the reminder can include interacting, by the user, with the information relevant to the user.

In another general aspect, a non-transitory, machine-readable medium having instructions stored thereon, the instructions, when executed by a processor, can cause a computing device to execute a search engine application, receive, at a first time and in a graphical user interface of the search engine application, one or more search terms indicative of particular content of interest to a user, identify additional content related to the particular content based on the one or more search terms, determine that the additional content is available for access by the user at a second time later than the first time, provide, to a computer system, information indicative of an interest of the user to receive reminders about the particular content, the computer system creating a reminder for the user based on the one or more search terms indicative of the particular content of interest to the user and based on the user not accessing the additional content at the first time, the reminder being scheduled for the second time, receive, at the second time, the reminder indicating that the additional content related to the particular content is available for access by the user, and provide, by the computing device, a user experience for engaging with the content reminder.

Implementations can include one or more of the following features, alone or in combination with one or more other features. For example, receiving, by the computer device and at the second time, the reminder indicating that the additional content related to the particular content is available for access by the user can include receiving the reminder by at least one of a search engine, a voice-based assistant, and a calendar application. The reminder can further include information relevant to the user when accessing the available content. The user experience for engaging with the content reminder can include interacting, by the user, with the information relevant to the user.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system that includes a content manager.

FIG. 2 is a block diagram of entities included in a data model included in a content manager.

FIG. 3A is a diagram that shows an example user interface that presents an input field where a user of the web browser application can enter one or more search terms or queries for particular content.

FIG. 3B is a diagram that shows an example user interface for the calendar application that includes an example reminder.

FIG. 3C is a diagram that shows an example user interface that presents a pop-up reminder for particular content associated with one or more search terms.

FIG. 4 is a flowchart that illustrates a method for managing content by a computing device.

FIG. 5 is a flowchart that illustrates a method for automatically creating reminders.

FIG. 6 shows an example of a computer device and a mobile computer device that can be used to implement the techniques described here.

Like reference symbols in the various drawings indicate like elements.

### DETAILED DESCRIPTION

In some implementations, a single solution (e.g., a content manager) can be provided to a user for managing TV and movie content for viewing by the user on a variety of different devices (e.g., a television, a tablet device, a mobile phone and/or a laptop computer). The content manager can be available for access by the user on one or more of the devices of the user. The content manager can control, manage and synchronize reminders pertaining to the availability of content (e.g., TV shows, movies) that a user would like to access and view.

The content manager can include a data model for content reminders of variable specificity, where the content can be TV shows and/or movies. The content manager can include a system for allowing users to receive the content reminders based on an explicit and/or an implicit expression of interest. The content manager can include a user experience for receiving and engaging with a content reminder. For example, the content manager can be integrated into a search engine, a voice-based assistant, or any application that displays information about the content (e.g., movies and TV shows) to a user.

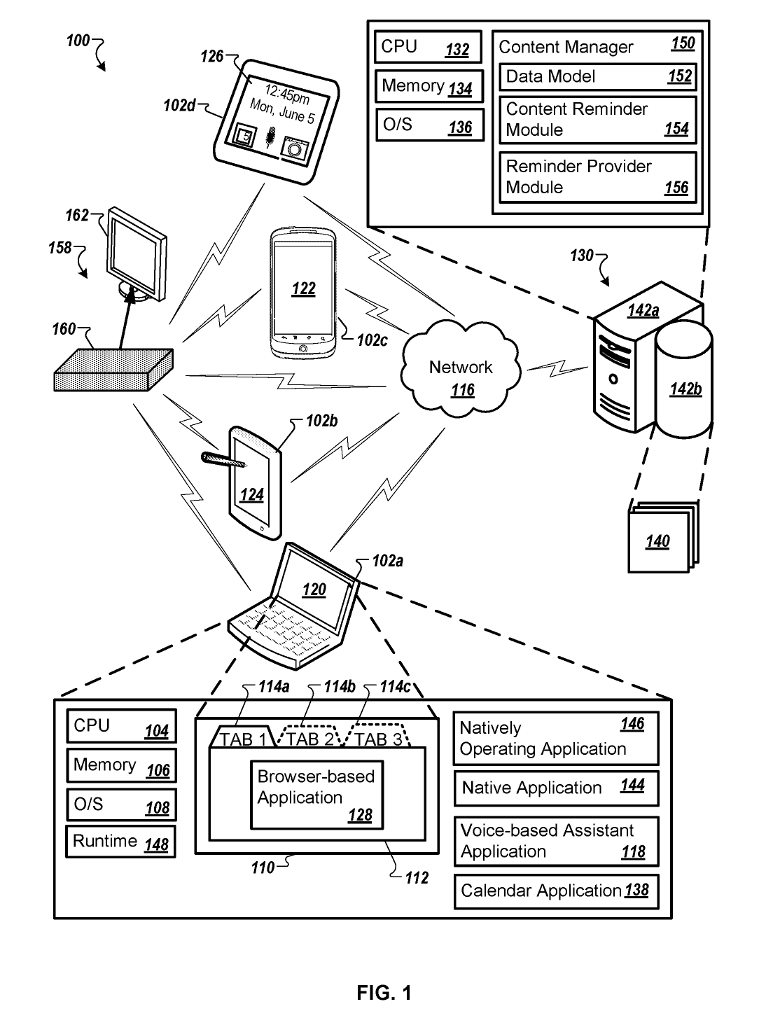

FIG. 1 is a block diagram of an example system 100 that includes a content manager 150. The example system 100 includes a plurality of computing devices 102a-d (e.g., a laptop computer, a tablet computer, a smart phone, and a wearable device, respectively). For example, a computing device (e.g., one or more of the computing devices 102a-d) can include a display (a screen) and one or more speakers that can be external to the computing device and that can be placed on a desk or tabletop or that can be mounted, for example, on a wall. For example, a computing device (e.g., one or more of the computing devices 102a-d) can include a microphone/speaker device or accessory that can be placed on a desk or tabletop or that can be mounted, for example, on a wall. In some implementations, a computing device can include a robot.

An example computing device 102a (e.g., a laptop or notebook computer) can include one or more processors (e.g., client central processing unit (CPU) 104) and one or more memory devices (e.g., client memory 106)). The computing device 102a can execute a client operating system (O/S) 108 and one or more client applications (e.g., a web browser application 110) that can display a user interface (UI) (e.g., web browser UI 112) on a display device 120 included in the computing device 102a. Though not shown in FIG. 1, the computing devices can also include a desktop computing device.

The system 100 includes a computer system 130 that can include one or more computing devices (e.g., server 142a) and one or more computer-readable storage devices (e.g., repository 142b). The server 142a can include one or more processors (e.g., server CPU 132), and one or more memory devices (e.g., server memory 134). The computing devices 102a-d can communicate with the computer system 130 (and the computer system 130 can communicate with the computing devices 102a-d) using a network 116. The server 142a can execute a server O/S 136. The repository 142b can include content 140. For example, the content 140 can include video and/or audio content or streaming media that the content manager 150 can manage for a user of the computing device 102a.

In some implementations, the computing devices 102a-d can be laptop or desktop computers, smartphones, personal digital assistants, portable media players, tablet computers, wearable devices, or other appropriate computing devices that can communicate, using the network 116, with other computing devices or computer systems. In some implementations, the computing devices 102a-d can perform client-side operations, as discussed in further detail herein. Implementations and functions of the system 100 described herein with reference to computing device 102a, also may be applied to computing device 102b, computing device 102c, computing device 102d, and other computing devices not shown in FIG. 1 that may also be included in the system 100. The computing device 102b includes a display area 124. The computing device 102c includes a display area 122. The computing device 102d includes a display area 126.

In some implementations, the computer system 130 can represent more than one computing device working together to perform server-side operations. For example, though not shown in FIG. 1, the system 100 can include a computer system that includes multiple servers (computing devices) working together to perform server-side operations. In this example, a single proprietor can provide the multiple servers. In some cases, the one or more of the multiple servers can provide other functionalities for the proprietor. In a non-limiting example, the computer system can also include a search server and a web crawler server.

In some implementations, the repository 142b can represent more than one repository. For example, though not shown in FIG. 1, the repository 142b can include multiple repositories that each provide a particular type of content. For example, a first repository can provide TV shows, a second repository can provide movies, and a third repository can provide streaming media video clips. In some implementations, a single proprietor can provide the multiple repositories. In some implementations, a single proprietor can provide one or more but not all of the multiple repositories allowing multiple proprietors to provide the multiple repositories. In all of these examples, the content manager 150 can manage, for a user and for access by a computing device, content included on one or more of the multiple repositories

In some implementations, the network 116 can be a public communications network (e.g., the Internet, cellular data network, dialup modems over a telephone network) or a private communications network (e.g., private LAN, leased lines). In some implementations, the computing devices 102a-d can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, supersonic audio signals, etc.).

The system 100 includes a television (TV) system 158. In some implementations, the computing devices 102a-d can interface to/communicate with the TV system 158 using the network 116. Similarly, the TV system 158 can interface to/communicate with the computing devices 102a-d. The TV system 158 can communicate with the computer system 130 using the network 116. Similarly, the computer system 130 can communicate with the TV system 158 using the network 116. The TV system 158 can include a TV interface device 160 that provides an interface between the network 116 and a display device 162 (e.g., a television set). In some implementations, the TV interface device 160 may plug into/be directly connected to the display device 162. In some implementations, the TV interface device 160 can be included as part of the display device 162.

The TV system 158 can receive content from the repository 142b by way of the server 142a and the network 116. For example, a user can use a computing device (e.g., one or more of the computing devices 102a-d) to interface with the TV interface device 160 and the computing system 130 to control the content provided to the TV system 158. In some implementations, the computing devices 102a-d can communicate directly with the TV system 158 and specifically the TV interface device 160 using, for example, one or more high-speed wired and/or wireless communications protocols such as Bluetooth, Bluetooth Low Energy (Bluetooth LE), and WiFi.

In some implementations, the computing device 102a can run, or cause the operating system 108 to execute, the web browser application 110. The web browser application 110 can then provide, in the web browser UI 112, a plurality of panes or tabs 114a-c. The web browser UI 112 can be a visual area, usually rectangular, containing some kind of user interface. In a graphical user interface (GUI) used in the computing device 102a, the web browser UI 112 can be a two-dimensional object arranged on a plane of the GUI known as a desktop. The web browser UI 112 can include other graphical objects (e.g., a menu-bar, toolbars, controls, icons). The web browser UI 112 can display the graphical objects on the display device 120. A user of the computing device 102a can interact with the graphical objects to provide input to, or otherwise control the operation of, the web browser application 110.

The web browser UI 112 can include a working area in which a document, an image, folder contents, or other objects including information or data for the browser-based application 128 can be displayed. The working area can include one main object (e.g., a single web document interface) or multiple objects (e.g., more than one web document interface), where each object can be displayed in a separate window (or tab). Each tab can include a UI. In some applications, specifically web browser applications, multiple documents can be displayed in individual tabs 114a-c. The tabs 114a-c can be displayed one at a time, and are selectable using a tab-bar, which can reside above the contents of an individual window. That is, one selected tab (e.g., tab 114a) can be considered forward-facing (in the foreground). The tab 114a can display information or content to a user in the web browser UI 112, while the content of other tabs 114b, 114c can be considered “hidden” (in the background).

In some implementations, the web browser application 110 can interface with the content manager 150. The web browser application 110 can provide information about the content 140 included in the repository 142b. For example, a search engine (a search engine application) included as part of the web browser application 110 can take input provided by a user of the web browser application 110 in the web browser UI 112. The input can be for information about particular content included in the repository 142b. Responsive to the search, the web browser UI 112 can display information about the requested content. The content manager 150 can determine an interest of the user for the particular content and can further provide reminders about availability of the requested content.

In some implementations, the web browser application 110 can include or be associated with one or more browser-based applications (e.g., a browser-based application 128). The browser-based application 128 can be executed/interpreted by the web browser application 110. The browser-based application 128 executed by the web browser application 110 can include code written in a scripting language, such as, JavaScript, VBScript, ActionScript, or other scripting languages.

A browser-based application may be configured to perform a single task or multiple tasks for a user. In such an implementation, the browser-based application may be configured to be executed or interpreted by the web browser. This is compared with the native applications (e.g., native application 144) that include machine executable code and are configured to be executed directly via the operating system of the client device, whereas, a browser-based application may be incapable of execution or display without the aid of the web browser. Thus, browser-based applications can be run inside a browser with a dedicated user interface, and can provide functionality and an experience that is more rich and interactive than a standalone website but are less cumbersome and monolithic than a native application 144. Examples of browser-based applications include, but are not limited to, games, photo editors, and video players that can run inside the web browser application 110. The browser-based application 128 can provide a dedicated UI for display on the display device 120.

The browser-based application 128 can provide the content for viewing by the user. For example, in cases where the browser-based application 128 is a video player, the browser-based application 128 can play the video or image portion of the content on the computing device 102a for viewing by the user on the display device 120. In addition or in the alternative, the browser-based application 128 can play the audio portion of the content on one or more speakers (not shown) included on the computing device 102a.

Browser-based applications can be “hosted applications” or “packaged applications.” Hosted applications may include at least a portion of a web site that itself includes web pages, in addition to some metadata that may be especially pertinent to the browser-based application or to the user of the browser-based application to allow the browser-based application to perform some particular functionality for the user. Packaged applications can be thought of as browser-based applications whose code is bundled, so that the user can download all of the content of the browser-based application for execution by the browser. A packaged browser-based application may not need to have network access to perform its functionality for the user, and rather may be executed successfully by the browser locally on the computing device without access to a network. Packaged browser-based applications have the option of using Extension APIs, allowing packaged applications to change the way the browser behaves or looks.

In some implementations, a natively operating application 146 can be an application that executes (runs) either directly on the CPU 104 and by the O/S 108. In some implementations, the natively operating application 146 can be an application that executes (runs) on top of a virtual machine (VM) (e.g., a Java VM) on the computing device 102a. In some cases, the natively operating application 146 can be compiled. For example, the computing device 102a can download and install the natively operating application 146 from a marketplace server using a web browser application (e.g., web browser application 110). The natively operating application 146 may operate using a runtime 148. The natively operating application 146 may be configured to be executed directly by the CPU 104 or by the O/S 108, using a runtime 148, for example. Because natively operating application 146 is coded using web technologies, no compilation step is required.

The computing device 102a can include a voice-based assistant application 118 and a calendar application 138. In some implementations, the voice-based assistant application 118 and the calendar application 138 can interface with the content manager 150. As described, the web browser application 110 can interface with the content manager 150. The content manager 150 can identify and/or define one or more user contexts that can activate a user reminder about a particular content included in the content 140.

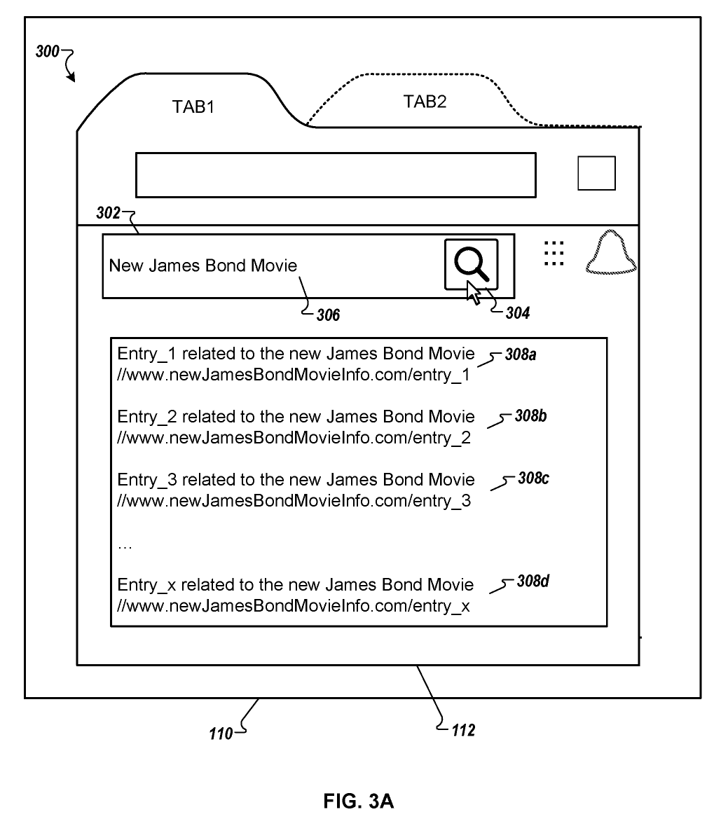

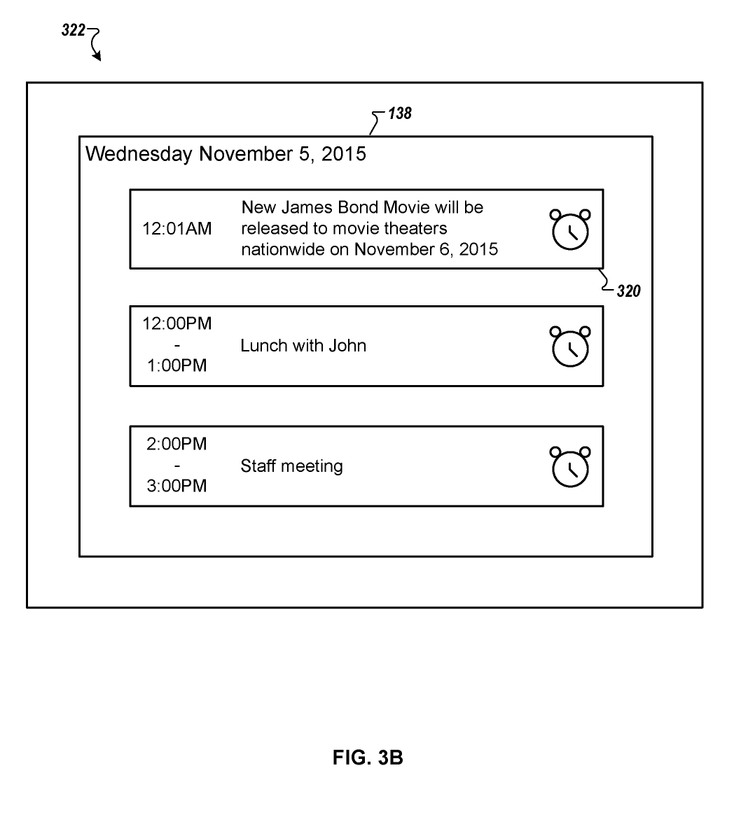

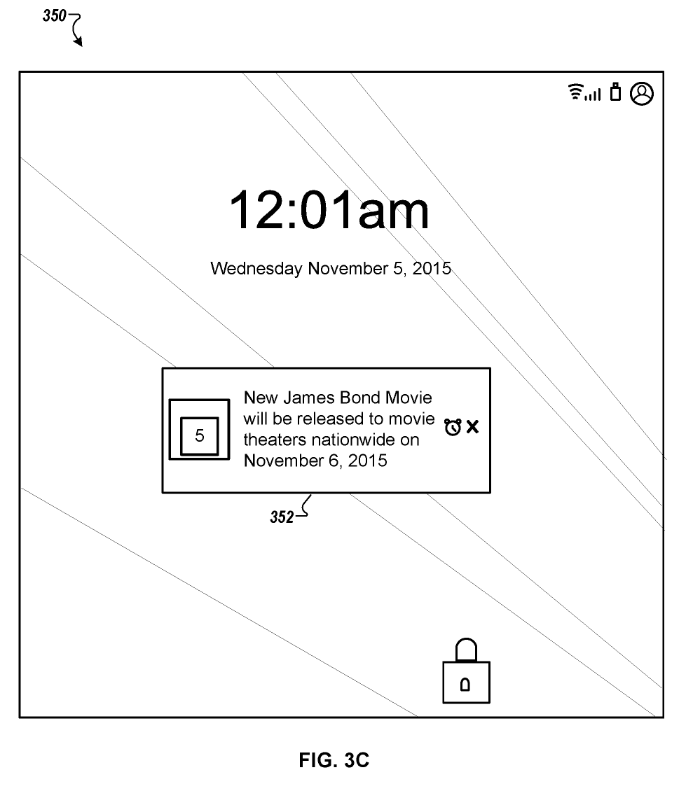

In some implementations, a user context can be defined by a set of actions taken by a user involving a particular content that, for example, indicates interest in the content by the user (e.g., an implicit expression of interest). For example, the content manager 150 can identify a set of actions by interfacing with the web browser application 110, the voice-based assistant application 118, and the calendar application 138. The content manager 150 can identify interactions with the web browser application 110, the voice-based assistant application 118, and the calendar application 138 with regards to the content 140 included in the repository 142b. Examples of such interactions are further described herein with reference to FIGS. 3A-C and 4.

In some implementations, a user context can be defined based on prior manual definitions of contexts by the user (e.g., an explicit expression of interest). For example, the content manager 150 can interface with the web browser application 110, the voice-based assistant application 118, and the calendar application 138 to determine manual definitions of contexts as pertaining to the content 140 included in the repository 142b.

In some implementations, the content manager 150 can interface with one or more natively operating applications (e.g., the natively operating application 146), one or more native applications (e.g., the native application 144), and one or more browser-based applications (e.g., the browser-based application 128). In some implementations, the voice-based assistant application 118 can be a browser-based application. In some implementations, the voice-based assistant application 118 can be a natively operating application. In some implementations, the voice-based assistant application 118 can be a native application. In some implementations, the calendar application 138 can be a browser-based application. In some implementations, the calendar application 138 can be a natively operating application. In some implementations, the calendar application 138 can be a native application.

In some implementations, the content manager 150 can be included in the computing device (e.g., one or more of the computing devices 102a-d). The content manager 150 can interface with the voice-based assistant application 118, the calendar application 138, one or more natively operating applications (e.g., the natively operating application 146), one or more native applications (e.g., the native application 144), and one or more browser-based applications (e.g., the browser-based application 128). The content manager 150 can interface with the computer system 130 in order to access the repository 142b and manage the content 140.

The content manager 150 includes a data model 152, a content reminder module 154, and a reminder provider module 156. The data model 152 can be a model for content reminders of variable specificity, where the content can be, for example, TV shows and/or movies. The content reminder module 154 provides content reminders for a user based on an explicit and/or an implicit expression of interest by the user. The reminder provider module 156 can provide a user experience for receiving and/or engaging with a content reminder.

The content manager 150 can define one or more user contexts that can activate a user reminder about a particular content. For example, a user context can be defined by a set of actions taken by a user involving a particular content that, for example, indicated interest in the content by the user (e.g., an implicit expression of interest).

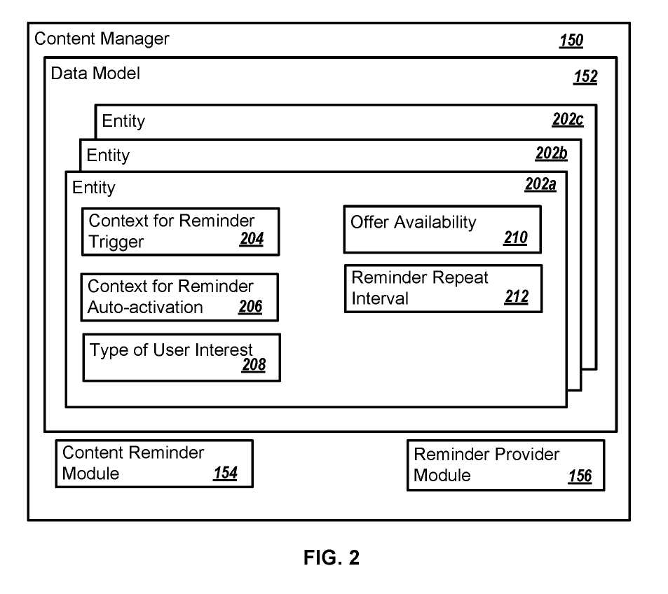

FIG. 2 is a block diagram of entities 202a-c included in the data model 152 included in the content manager 150 as shown in FIG. 1. Each entity 202a-c can be associated with particular content that a user is interested in receiving reminders about. Each entity 202a-c can include information and criteria for use in generating one or more reminders about the availability of content specified by the entity. The specific information and criteria can include, but is not limited to, a context for reminder trigger 204, a context for reminder auto-activation 206, a type of user interest 208, an offer availability type 210, and a reminder repeat interval 212.

For example, content can be a movie, a TV show, a TV episode, a TV season, a streaming media video clip, a video clip pertaining to a particular TV show, or a video clip pertaining to a particular movie (e.g., a movie trailer). Referring to FIG. 1, in some implementations, information related to the content can be stored in the repository 142b. In some implementations, the content itself (e.g., a TV show, a movie) can be stored in the repository 142b as content 140 and information related to the content can be stored in the repository 142b in association with the content.

An entity (e.g., the entity 202a) can include the offer availability type 210 that includes information about an offer related to the content. The information about an available content offering (e.g., the offer availability type 210) can include the identity of and information about (can specify) a platform that can provide the available content offering. For example, platforms can include, but are not limited to, live TV, a movie theater, a streaming platform or service, a digital video disc (DVD), and a Blu-ray disc. The information about an available content offering (e.g., the offer availability type 210) can include a cost for the available offer (e.g., free, a particular price, free with subscription, free for a specific user). The information about an available content offering (e.g., the offer availability type 210) can include a timeframe or window of availability for the content offering. Examples of the frame or window of availability for the content offering can include, but are not limited to, a date and time that a TV show will air on, a range of days (e.g., from March 1st to April 1^{st}) that a particular movie is available on-demand from a provider of Internet streaming media, a date that a particular movie will be released in movie theaters.

In some implementations, the context for reminder trigger 204 can include at least one specific criterion (e.g., one or more criteria or one or more rules) for a context in which to trigger a reminder (a notifier) for a user about the available content offering. For example, the one or more rules or criteria can be pre-computed, computed on the fly when a user is on-line, computed on a periodic basis, computed each time at least one new rule or criterion is available, and/or computed when new knowledge may be acquired in association with the user and/or the content offering. In some cases, rules can be updated when a user changes subscriptions. In some cases, rules can be updated when a user sets up payments from a content provider. In some cases, rules can be updated when a user sets up or executes at least one purchase from a content provider.

In some implementations, the context for reminder trigger 204 can specify a time or time window in which to trigger a reminder to the user about the availability of the content offering. For example, the context for reminder trigger 204 can specify the triggering of a reminder to the user as soon as the specified content offering is available. In some cases, multiple time windows can be specified and can subsequently trigger additional reminders to the user about the availability of the content. For example, the multiple time windows and reminder triggers can include triggering a reminder as soon as the content is available, triggering another reminder when the availability of the content becomes active, and triggering another reminder right before the availability of the content expires.

In addition or in the alternative, in some implementations, the context for reminder trigger 204 can specify a physical location. For example, when a computing device of the user (e.g., the computing devices 102a-d shown in FIG. 1) is determined to be within a certain predefined geographic location a reminder to the user about the availability of the content offering can be triggered. For example, the content offering can be a movie and the geographic location can be a movie theater. A reminder can be triggered when the movie is showing at the movie theater and the computing device of the user is determined to be near the movie theater. In another example, the content offering can be a TV show and the geographic location can be the home of a user. A reminder can be triggered when the TV show is available for viewing on the TV of the user and the computing device of the user is determined to be near the home of the user.

Various technologies can be used to detect the proximity of a computing device of a user to a geographic location. For example, the computing device can detect the proximity of the geographic location using technologies such as global positioning coordinates (GPS), Wi-Fi beacons, or Bluetooth/Bluetooth Low Energy (Bluetooth LE) communication protocols. For example, the computing device of the user can be determined to be in proximity to another computing device at the geographic location that can provide the available content when the computing device of the user and the computing device at the geographic location are within the range of a particular communication system. For example, the TV of the user may include a computing device that can automatically establish short-range communications with the computing device of the user when the computing device of the user is within the range of the short-range communication capability of the computing device in the TV.

The context for reminder auto-activation 206 can specify a context in which to auto-activate a reminder. For example, a reminder can be auto-activated whenever a new episode of a TV show of interest to a user is available for viewing by the user. In another example, a reminder can be auto-activated when it is determined that a user is performing entertainment related planning activities (e.g., the context is a user planning a trip). For example, the reminder can be for the user to pre-load movies, videos, music, or other types of entertainment media to a computing device for listening to and/or viewing while they are traveling (e.g., on an airplane, in a car, on a train) on the plane. In another example, a reminder can be auto-activated when it is determined that a user is planning a party or date. For example, the reminder can be for the user to pre-load movies, videos, music, or other types of entertainment media that they may want to play or view during the planned party or date. In some cases, the planning activities of a user can be inferred from search and browsing activities, such as visiting travel related sites (e,g, airline web sites, hotel web sites). In some cases, the planning activities of a user can be inferred from the exchanging and/or sending of emails to others about a particular planned event (e.g., a party, a meeting, a gathering),

The reminder repeat interval 212 can specify how often a reminder for availability of the same content may be re-triggered or repeated (a repeat interval). For example, a reminder can be re-triggered or repeated hourly, daily, or weekly during the time when the content is available. In some implementations, machine learning can be used to determine an optimum repeat or re-triggering frequency. In some implementations, machine learning can be used to determine a specific time to repeat or re-trigger the reminder (e.g., when a user is commuting, when a user has arrived home from work, when a user wakes up).

The type of user interest 208 can indicate whether the content for which a reminder is set is of explicit or implicit interest to the user. The type of user interest 208 can indicate that content is of explicit interest to a user if the user specifically sets a reminder for triggering when the content is available. For example, a user sets a reminder to trigger when a particular episode of a TV show is available for viewing.

The type of user interest 208 can indicate that a specific content is of implicit interest to a user if the user has shown interest in related content. The type of user interest 208 can indicate that a specific content is of implicit interest to a particular user if users who have profiles similar to a profile associated with the particular user have shown interest in specific content. For example, a reminder can be set to trigger when a particular episode of a TV show is available for viewing based on prior reminders being triggered for past episodes of the TV show. For example, a user can perform Internet searches for a movie that has yet to be released to theaters. A reminder can be set to trigger when the movie is released to theaters.

In some implementations, the content manager 150 can access particular content included in the content 140 included in the repository 142b based on a scheduled reminder associated with the particular content. The computer system 130 (e.g., the content reminder module 154 included in the content manager 150) can provide a reminder to the computing device 102a based on intrinsic behavior of the user. The reminder can be for accessing the particular content included in the content 140. At a time when the reminder triggers, the computing device 102a can obtain the particular content from the computer system 130 (e.g., the particular content from the content 140 included in the repository 142b). Determining when the reminder triggers can be based on one or more behaviors of the user (e.g., an intrinsic behavior of the user). In some implementations, the intrinsic behavior of the user can be associated with a physical location. For example, a behavior of the user can be leaving a house at 9:00 am Monday through Friday to board a bus to work. A reminder can be scheduled to trigger at 8:15 am Monday through Friday (45 minutes before needing to leave for the bus). When the alarm triggers, the computing device 102a can obtain the particular content from the computer system 130 for caching (queueing or storing) on the computing device 102a. The content would then be available for viewing by the user on the display device 120 of the computing device 102a while the user rides the bus.

Referring FIG. 2, each entity (e.g., entities 202a-c) can define one or more contexts that can activate a user reminder about a particular content. In some implementations, a context can be defined by a set of actions taken by a user involving the particular content that can be indicative of an interest in the content by the user (i.e., an implicit expression of interest by the user).

For example, a user can interact with the web browser UI 112, entering search terms about content (e.g., a movie, TV show, album, song, or book) that has not been publicly released. Based on this intrinsic interest of the user in the content, a user reminder can be automatically set for activation at the time (e.g., the day, the hour) when the release date for the content is publicly known, announced, or otherwise disclosed. In some cases, knowledge of the release date for the content may be before (e.g., days, weeks, or months before) the actual date that the content is released and made available to the public. In addition or in the alternative, a user reminder can be automatically set for the exact date and time (e.g., the day, hour, minute, and/or second) the content will be publicly available.

For example, a user searches for a trailer for a particular movie that has not yet been released to the public. Referring to FIG. 2, an entity (e.g., entity 202a) can be associated with the particular movie based on the intrinsic interest of the user in the particular movie. In some cases, for example, a user reminder can be automatically set for activation when the particular movie is scheduled to be released to movie theaters. The type of user interest 208 can indicate that the particular movie is of implicit interest to the user. The offer availability type 210 can include a movie theater. The context for reminder trigger 204 can specify triggering a reminder as soon as the release date for the movie is announced. In addition or in the alternative, the context for reminder trigger 204 can specify triggering a reminder when the content is publicly available (showing in movie theaters). In addition, the context for reminder trigger 204 can specify a geographic location within which to trigger the reminder.

For example, a computing device of a user can trigger a reminder when the particular movie is showing at a movie theater determined to be within a particular proximity of the computing device. The reminder repeat interval 212 can specify how often a reminder about the availability of the particular movie may be re-triggered or repeated. For example, a reminder can be re-triggered or repeated daily from the time of the public announcement of the release date until the actual release date of the particular movie into theaters. In some cases, over time, a re-trigger frequency, a time of day, and/or other context for re-triggering or repeating the reminder can be optimized based on a history of responses to other reminders. For example, a reminder can be re-triggered at particular time of day (e.g., when a user is commuting, when a user is having lunch) based on positive (e.g., yes) responses to other reminders that were scheduled to trigger during these timeframes. For example, a reminder may not be re-triggered at particular time of day (e.g., when a user is in a meeting) based on negative (e.g., no) responses to other reminders that were scheduled to trigger during these timeframes. In addition, the context for reminder auto-activation 206 can specify auto-activating a reminder when the particular movie is available for purchase for in-home viewing (e.g., on a Blu-ray disc, a DVD, from a streaming media provider). In this case, the offer availability type 210 can further include a Blu-ray disc, a DVD, and a streaming media provider.

For example, a user can enter a search query for information about a particular TV show or series (e.g., online reviews, list of cast members, general plot synopsis, TV channel airing the TV series live). Referring to FIG. 2, an entity (e.g., entity 202a) can be associated with the particular TV series based on the intrinsic interest of the user in the particular TV series. In some cases, for example, a user reminder can be automatically set for activation when the next episode of the particular TV series is scheduled for airing live on TV. In some implementations, the user can indicate if the user reminder should be automatically set for a first run episode and/or a rerun of the episode. The type of user interest 208 can indicate that the particular TV series is of implicit interest to the user. The offer availability type 210 can include the platform that can provide the next episode of the particular TV series, such as live TV or a streaming platform or service. The offer availability type 210 can include a timeframe or window of availability for the offering of the next episode of the particular TV series, such as a date and time that the next episode of the particular TV series will air on live TV, and/or a range of days that the next episode of the particular TV series is available on-demand from a provider of an Internet streaming media service. The context for reminder trigger 204 can specify triggering a reminder as soon as the date for the airing of the next episode of the particular TV series is announced. In addition, the context for reminder trigger 204 can specify a geographic location within which to trigger the reminder.

For example, a computing device of a user can trigger a reminder when the computing device is in the home of the user (e.g., the location of a TV for viewing the episode of the particular TV series). The reminder repeat interval 212 can specify how often a reminder about the availability of the next episode of the particular TV series may be re-triggered or repeated. For example, a reminder can be re-triggered or repeated daily (or at another particular time interval such as every other day or weekly) from the time of the announcement of when the next episode of the particular TV series is scheduled for airing on live TV until the time when the next episode of the particular TV show is no longer available for viewing on-demand from a provider of an Internet streaming media service. In addition, the context for reminder auto-activation 206 can specify auto-activating a reminder when the next episode of the particular TV show is available for purchase (or for free) for in-home viewing provided by another delivery mechanism (e.g., on a Blu-ray disc, a DVD, from a streaming media provider). In this case, the offer availability type 210 can further include a Blu-ray disc, a DVD, and a streaming media provider.

For example, a user can enter a search query for when a particular movie will be available for in-home viewing. Referring to FIG. 2, an entity (e.g., entity 202a) can be associated with the particular movie based on the intrinsic interest of the user in the particular movie. The particular movie may be available for in-home viewing on multiple different types of formats. In some cases, for example, individual user reminders can be automatically set for activation for each available type of delivery format when the particular movie is available for delivery to the user in the particular format. For example, a first user reminder can be automatically set when the particular movie is available for purchase on a Blu-ray disk. For example, a second user reminder can be automatically set when the particular movie is available for purchase on a DVD. For example, a third user reminder can be automatically set when the particular movie is available for purchase from a streaming media provider. For example, a user may have a subscription with a particular streaming media provider. A fourth user reminder can be automatically set when the particular movie is available for free rental from the particular streaming media provider that the user subscribes to.

The type of user interest 208 can indicate that the particular movie is of implicit interest to the user. In some implementations, a provider of a user reminder can also provide space on the reminder that can be supported by one or more advertisements (ads) (e.g., ad supported space). In some implementations, a reminder can include two parts or sections. For example, a first section can include sources for a particular content ranked in order of a type of relevance to the user (e.g., sources that include the particular content that a user subscribes to can be ranked (placed) higher than sources that include the particular content that a user does not subscribe to). For example, a second section can an add supported section that can include other sources or providers of the particular content in a different order such as, for example, in an order of business consideration (e.g. a highest bidder source can be ranked (placed) first).

The offer availability type 210 can include the platform that can provide the particular movie (e.g., a Blu-ray disk, a DVD, a streaming platform or service). The offer availability type 210 can include a timeframe or window of availability for purchasing, renting, or streaming the particular movie. For example, the offer availability type 210 can include, for each platform that can provide the particular movie, a date and time that the particular movie is first available for in-home viewing on the particular platform until a date and time that the particular movie no longer available for in-home viewing on the platform. For example, a streaming platform may have the particular movie available for in-home viewing during a particular timeframe (e.g., one month, from a start date to an end date). For example, the particular movie may be available for purchase on a Blu-ray disk for many months or years.

The context for reminder trigger 204 can specify triggering a first reminder when the particular movie is first available for purchase on a DVD. The context for reminder trigger 204 can specify triggering a second reminder when the particular movie is first available for purchase on a Blu-ray disk. The context for reminder trigger 204 can specify triggering a third reminder when the particular movie is first available for purchase from a streaming media provider. The context for reminder trigger 204 can specify triggering a fourth reminder when the particular movie is first available for free download or rental from a streaming media provider that the user subscribes to.

In addition, the context for reminder trigger 204 can specify a geographic location within which to trigger the reminder. For example, a computing device of a user can trigger a reminder when the computing device is in the home of the user (e.g., the location of a TV for streaming the particular movie, the location of a media player and TV for playing the Blu-ray disk or DVD). The reminder repeat interval 212 can specify how often a reminder about the availability of the particular movie may be re-triggered or repeated. In some cases, a reminder can be provided by a device that can provide the particular content. For example, a computing device of a user can trigger a reminder when the computing device is in proximity to (is within a particular distance of) a TV (e.g., a user holding the computing device is in front of the TV). The TV can display the reminder when the user turns the TV on. In some cases, the reminder can be triggered when a particular action occurs when the computing device is in proximity to (within a certain distance of) the device that can provide the content. For example, a reminder can be triggered and provided on a computing device of a user when the computing device is in proximity to a TV (e.g., a user is holding the computing device while in front of the TV, a user is standing near the TV with the computing device in a pocket) and the user turns the TV on, Proximity between devices can be determined using one or more communication protocols (e.g., WiFi, Bluetooth, Bluetooth LE, supersonic audio signals). In some implementations, the reminder repeat interval 212 can be different for each reminder and/o different for each providing platform. For example, a reminder can be re-triggered or repeated daily (or at another particular time interval such as every other day or weekly) from the time when the particular movie is first available for free access (e.g., download or rental) from a streaming media provider that the user subscribes to until the particular movie is no longer available for free access. For example, in cases where the particular movie may be available for purchase for a limited time from a streaming media provider, the context for reminder auto-activation 206 can specify auto-activating a reminder when the particular movie is available for free for in-home viewing by the same streaming media provider or by a different streaming media provider. In this case, the offer availability type 210 can include a Blu-ray disc, a DVD, and multiple streaming media providers.

In some implementations, each context for reminder trigger 204 and/or each context for reminder auto-activation 206 can be manually defined (e.g., defined by a user) for a data model (e.g., the data model 152), for a specific entity (e.g., entity 202a), and/or for each specific content offering for the entity. In some implementations, a user may indicate that they prefer not to pay for movies available for in-home viewing. For example, context for reminder triggers and/or context for reminder trigger auto-activations can be manually defined (e.g., defined by a user) for the data model (e.g., the data model 152) that can be applied to entities associated with movies. Reminders can be automatically set for movies only when they become available for free purchase, downloading, or streaming for in-home viewing. In some implementations, a user may indicate that they want to know when episodes of a particular TV series are available for live TV viewing only. For example, a context for reminder trigger 204 can be manually defined (e.g., defined by a user) and/or a context for reminder auto-activation 206 can be manually defined (e.g., defined by a user) for an entity associated with the particular TV series (e.g., the entity 202a). Reminders can be automatically set for episodes of the particular TV series only when they become available for live TV viewing.

In some implementations, reminders can be based on extrinsic behavior of the user. For example, a user can manually provide and define one or more contexts that can activate a reminder about particular content of interest to the user as manually identified by the user. A content manager (e.g., the content manager 150 as shown in FIG. 1) can define one or more user contexts that can activate a reminder to a user about particular content based on prior manual definitions of contexts by the user that are associated with the particular content. For example, a user can manually set a request for a reminder for specific content specified by the user (e.g., a particular TV show, a particular movie).

For example, a user can manually set a request for automatically generating a reminder when a next episode of a TV show will be aired on live TV. In some cases, a user can manually set rules that can be applied to categories of content rather than particular content. For example, a user can manually set rules that specify the setting of a reminder when a new episode of a TV show or series that the user has previously watched at least twice (the user has watched at least two episodes of the TV series) will be aired on live TV. In some cases, a user can manually set rules that specify a reminder time or frequency for a reminder. For example, a user can manually set rules that specify that a reminder can be triggered when the user is commuting home from work on week days.

Referring to FIG. 2, an entity (e.g., entity 202a) can be associated with the particular TV series based on the extrinsic interest of the user in the particular TV series (i.e., the user specifically set a request for a reminder regarding the TV show). The type of user interest 208 can indicate that the particular TV series is of explicit interest to the user. The offer availability type 210 can include the platform that can provide the next episode of the particular TV series (e.g., live TV). The offer availability type 210 can include a timeframe or window of availability for the offering of the next episode of the particular TV series. For example, the timeframe or window of availability can be one or more dates and one or more times that the next episode of the particular TV series will air on live TV (e.g. Sunday November 1 at 9:00 pm, Sunday November 1 at 11:00 pm, Sunday November 1 at 1:00 am, Monday November 2 at 2:00 am). For example, the context for reminder trigger 204 can specify triggering a reminder as soon as the date (or dates) for the live TV airing of the next episode of the particular TV series is announced.

In addition, the context for reminder trigger 204 can specify triggering a reminder for each date and time that the next episode of the particular TV series will air on live TV. For example, a reminder can be triggered for each of the Sunday November 1 at 9:00 pm, Sunday November 1 at 11:00 pm, Sunday November 1 at 1:00 am, and Monday November 2 at 2:00 am airings of the next episode of the TV show. The reminder repeat interval 212 can specify how often a reminder about the availability of the next episode of the particular TV show may be re-triggered or repeated. For example, a reminder can be re-triggered or repeated daily (or at another particular time interval such as every other day or weekly) from the time of the announcement of when the next episode of the particular TV series first is scheduled for airing on live TV until the time when the next episode of the particular TV show is no longer available for viewing on live TV. In addition, the context for reminder auto-activation 206 can specify auto-activating a reminder when the next episode of the particular TV show is available for purchase (or for free) for in-home viewing provided by another delivery mechanism (e.g., on a Blu-ray disc, a DVD, from a streaming media provider, on-demand from a provider of an Internet streaming media service). In this case, the offer availability type 210 can further include a Blu-ray disc, a DVD, an Internet streaming media service, and a streaming media provider.

For example, a user can manually set a request for automatically generating a reminder when a particular movie will be available for streaming from a subscription service that the user subscribes to. Referring to FIG. 2, an entity (e.g., entity 202a) can be associated with the particular movie based on the extrinsic interest of the user in the particular movie (i.e., the user specifically set a request for a reminder regarding the particular movie). The type of user interest 208 can indicate that the particular movie is of explicit interest to the user. The offer availability type 210 can include the platform that can provide the particular movie (e.g., the subscription service). The offer availability type 210 can include a timeframe or window of availability for the offering of the particular movie. For example, the timeframe or window of availability can be a start date and an end date (e.g., the particular movie is available on the subscription service from January 1 to March 31). For example, the context for reminder trigger 204 can specify triggering a reminder as soon as the date (or dates) for the availability of the particular movie from the subscription service is announced.

In addition, the context for reminder trigger 204 can specify triggering a reminder on the start date for the availability of the particular movie from the subscription service. In addition, the context for reminder trigger 204 can specify triggering a reminder on the end date for the availability of the particular movie from the subscription service. The reminder repeat interval 212 can specify how often a reminder about the availability of the particular movie may be re-triggered or repeated. For example, a reminder can be re-triggered or repeated daily (or at another particular time interval such as every other day or weekly) from the date of the announcement of when the particular movie is first available from the subscription service until the start date for the availability of the particular movie from the subscription service.

For example, a reminder can be re-triggered or repeated daily (or at another particular time interval such as every other day or weekly) from the start date for the availability of the particular movie from the subscription service until the end date for the availability of the particular movie from the subscription service. In addition, the context for reminder auto-activation 206 can specify auto-activating a reminder when the particular movie is available for purchase (or for free) for in-home viewing provided by another delivery mechanism (e.g., on a Blu-ray disc, a DVD, from another streaming media provider, on-demand from a provider of an Internet streaming media service). In this case, the offer availability type 210 can further include a Blu-ray disc, a DVD, an Internet streaming media service, and another streaming media provider.

In some implementations, a user can identify and provide one or more criteria for triggering a reminder about the specified content. A content manager (e.g., the content reminder module 154 included in the content manager 150 shown in FIG. 1) can pre-compute the availability of the specified content based on the criteria identified and provided by the user to the content manager. The criteria can include, but is not limited to, a delivery mechanism for the content, a timeframe of availability for the content, and a cost associated with the content. The content manager (e.g., the content reminder module 154 included in the content manager 150 shown in FIG. 1) can pre-compute the availability of the requested content based on the use of valid combinations of the criteria. For example, an offer for a movie on a DVD can specify a price with no expiration date. In another example, streaming content may be available to a user over a specified date range and may expire (may no longer be available) beyond the specified date range, and for a subscriber to the service providing the streaming content, will not specify a price. In another example, setting a reminder for a next episode of a TV show to be available in a movie theater is not relevant.

In some implementations, a user can select one or more aspects of the reminder. The one or more aspects of the reminder can include when the user is reminded (e.g., a particular date and time, a particular location). One or more aspects of the reminder can include how often the user is reminded (e.g., hourly, daily, weekly, only during a particular specified timeframe).

In some implementations, the content manager (e.g., the reminder provider module 156 included in the content manager 150 as shown in FIG. 1) can identify one or more commonly used reminders for the content specified by the user. The content manager can provide one or more examples of the commonly used reminders to the user as suggestions to the user when selecting and entering a reminder for the specified content. The commonly used reminders can be based on specific contexts associated with a user and/or criteria previously specified by the user. For example, when a user enters a reminder for a movie, the content manager (e.g., the reminder provider module 156 included in the content manager 150 as shown in FIG. 1) can suggest automatically generating a reminder when the movie is released for streaming for no cost from a streaming media provider that the user subscribes to.

In some implementations, an entity included in a data model (e.g., entity 202a included in the data model 152 as shown in FIG. 2) can be associated with particular content based on the extrinsic interest of the user in the content and the intrinsic interest of the user in the content. For example, a user can enter a search query for information about a particular TV show or series (e.g., online reviews, list of cast members, general plot synopsis, TV channel airing the TV series live) showing intrinsic interest of the user in the TV show. A content manager (e.g., the content manager 150 as shown in FIG. 1). In addition, for example, a user can manually set a request for automatically generating a reminder when a next episode of the TV show will be aired live on TV, showing extrinsic interest in the TV show.

In some implementations, a reminder associated with particular content can include additional information associated with the particular content. For example, the reminder can include information pertaining to the availability of the particular content. In another example, the reminder can include additional information that may be relevant to the user when obtaining or attempting to obtain the available content. For example, the particular content can be a movie and the additional information can include directions to a store that sells the movie on a DVD or Blu-ray Disk, and/or directions to a store, outlet, or kiosk near the user where the user can rent the movie on a DVD or Blu-ray disk. For example, the particular content can be a movie that is available in theaters and the additional information can include a link to a service where the user can obtain (buy) tickets to the movie. For example, the particular content can be a next episode of a TV show and the additional information can be a link can be an online player application for the next episode of a TV show.

In some implementations, the additional information can be based on a relatedness matrix signal associated with the setting of the request for the reminder (e.g. query refinements, document co-occurrence). For example, a user can enter a search query for when a particular movie will be available for in-home viewing on a Blu-ray disk. A user reminder can be automatically set when the particular movie is available on a Blu-ray disk. The additional information provided with the reminder can include directions to a store that sells the movie on a DVD or Blu-ray Disk, and directions to a store, outlet, or kiosk near the user where the user can rent the movie on a DVD or Blu-ray disk.

In some implementations, a user can request additional and/or subsequent reminders based on information included in a previous reminder. For example, a reminder can include a timeframe for the availability of the particular content and a user can request triggering of one or more additional reminders before the identified availably of the content expires. In another example, the reminder can include additional information such as directions to a store that sells the particular content on a DVD or Blu-ray Disk, and directions to a store, outlet, or kiosk near the user where the user can rent the particular content on a DVD or Blu-ray disk. A user can request triggering of one or more additional reminders when the particular content available for sale on a DVD or Blu-ray Disk is priced less than a current price for the DVD or Blu-ray disk.

In some implementations, the content manager (e.g., the reminder provider module 156 included in the content manager 150 as shown in FIG. 1) can monitor the use of manually configured reminders by a user for specific content and/or the engagement of the user with pre-configured reminders for the content specified by the user to use as signals or inputs to the content manager. The content manager can use the received signals or inputs to rank the triggering of one or more of the pre-configured reminders for content.

FIG. 3A is a diagram that shows an example user interface 300 that presents an input field 302 where a user of the web browser application 110 can enter one or more search terms or queries 306 for particular content. For example, a user can search for information about a particular movie that has not yet been released. The information can include, but is not limited to, a trailer, a cast list, a soundtrack and a plot summary. For example, referring to FIG. 1, the user interface 300 can be displayed on the display device 120 included in the computing device 102a.

The web browser application 110 can receive a selection of a search icon 304. The selection of the search icon 304 initiates a search for one or more web sites that may include information associated with the search terms received by the web browser application 110. In response, the web browser application 110 can provide Uniform Resource Locators (URLs) 308a-d that provide a reference (a link) to information associated with the search terms 306. In some cases, a user can select (interact with) one or more of the URLs 308a-d to access the specific information associated with the search terms 306. In some cases, a user may just view the URLs 308a-d and not select (interact with) any of the URLs 308a-d, not accessing the specific information associated with the search terms 306.

FIG. 3B is a diagram that shows an example user interface 322 for the calendar application 138 that includes an example reminder 320. The content manager 150 can interface with the calendar application 138 so that the reminder 320 can be entered in the calendar application 138 as shown in FIG. 3B. In some implementations, the content manager 150 can interface with a reminder-type application so that a reminder can be entered into the reminder-type application.

In some implementations, one or more reminders for the particular content associated with the search terms can be set to trigger when the particular content is available to the user. In some implementations, a trigger can be explicitly set from within a search session executing (running) in a search engine application (e.g., a search engine (a search engine application) included as part of the web browser application 110 as shown in FIG. 1). For example, a user can enter a search query asking if the new James Bond movie is available on DVD. A response to the query can be that the new James Bond movie is not yet available on DVD. The search engine application can prompt the user to set a reminder to trigger when the new James Bond movie is available on DVD. In another example, a user can enter a general query about content (e.g., what should I watch on TV tonight). The search engine application can prompt the user to set a reminder to trigger when particular content is available for viewing on TV on that night. In some implementations, a user can enter a search query using one or more inputs to a computing device such as voice input or keyboard entry.

The reminders can be created based on the intrinsic behavior of the user as described herein. Referring to FIG. 1, the content manager 150 can interface with the calendar application 138. Based on the search terms entered by the user, the content manager 150 can create the reminder 320. The reminder 320 can be entered for the date and time that the reminder 320 should trigger on the computing device 102a. For example, the reminder 320 can be set to trigger a few days before the new James Bond Movie is released to movie theaters.

FIG. 3C is a diagram that shows an example user interface 350 that presents a pop-up reminder 352 for the particular content associated with the search terms 306, shown in FIG. 3A. For example, referring to FIG. 1, the user interface 350 can be displayed on the display device 120 included in the computing device 102a.

In the example shown in FIGS. 3A-C, the reminder 320 triggers a few days before the particular content (e.g., the new James Bond Movie) is available in movie theaters (before the particular content is released) generating the pop-up reminder 352. The pop-up reminder 352 can be displayed as an overlay on the user interface 350.

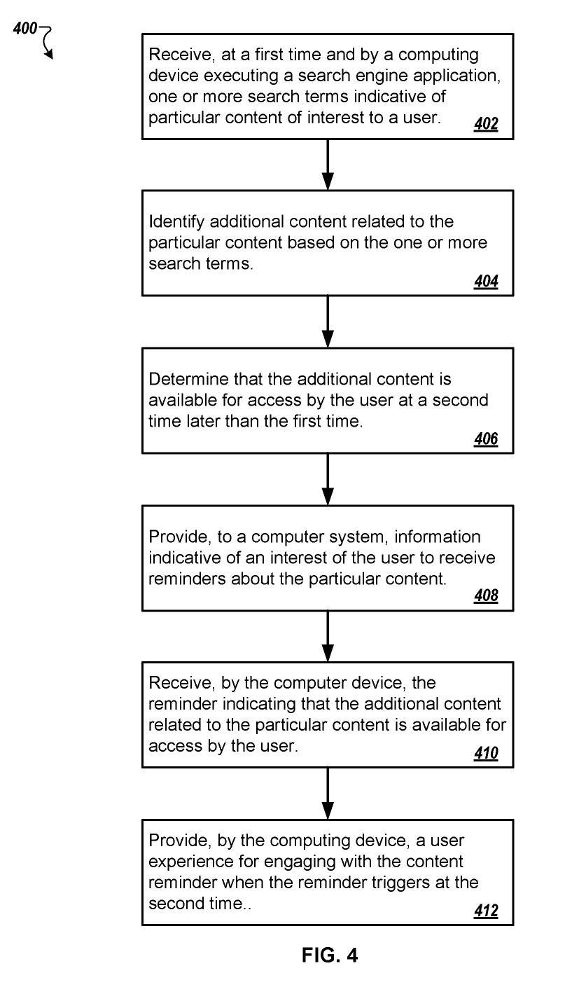

FIG. 4 is a flowchart that illustrates a method 400 for managing content by a computing device. In some implementations, the systems described herein can implement the method 400. For example, the method 400 can be described referring to FIGS. 1, 2, and 3A-C.

One or more search terms indicative of particular content of interest to a user are received at a first time and by a computing device executing a search engine application (block 402). For example, referring to FIG. 1 and FIGS. 3A-C, a search engine application can be included as part of the web browser application 110. The search engine application can accept input a provided by a user of the web browser application 110 in the web browser UI 112. Specifically, the user interface 300 for the search engine application can accept input (one or more search terms) entered by a user in the input field 302.

Additional content related to the particular content based on the one or more search terms is identified (block 404). For example, referring to FIG. 3A, the web browser application 110 can provide URLs 308a-d that provide a reference (a link) to information associated with the search terms 306 that include additional content related to the particular content. For example, the particular content can be the new James Bond movie, and the additional content related to the new James Bond movie can be a movie trailer, a cast list, a list of theaters that will be showing the movie, a soundtrack, and a plot summary.

It is determined that the additional content is available for access by the user at a second time later than the first time (block 406). For example, the soundtrack may not be available yet for downloading. The list of theaters that will be showing the movie may yet to be determined.

Information indicative of an interest of the user to receive reminders about the particular content is provided to a computer system (block 408). For example, referring to FIG. 1, the web browser application 110 can interface with the content manager 150. The web browser application 110 can provide information indicative of an interest of the user to receive reminders about the particular content based on the intrinsic interest of the user in the content (e.g., the user entered search terms related to the content). The computer system 130 (and specifically the content reminder module 154 included in the content manager 150) can create a reminder for the user based on the one or more search terms being indicative of the particular content of interest to the user and based on the user not accessing the additional content at the first time. The content reminder module 154 can schedule the reminder to trigger at the second time.

The reminder indicating that the additional content related to the particular content is available for access by the user is received by the computer device (block 410). For example, referring to FIG. 1, the computer system 130 (and specifically the content reminder module 154 included in the content manager 150) can provide the reminder to one or more applications included on the computing device 102a. For example, the computer system 130 can provide the reminder (e.g., reminder 320) to the calendar application 138. The calendar application 138 can trigger the reminder at the second time. In another example, the computer system 130 can provide the reminder to the voice-based assistant application 118. The voice-based assistant application 118 can trigger the reminder at the second time.

A user experience for engaging with the reminder when the reminder triggers at the second time is provided by the computing device (block 412). For example, referring to FIG. 3C, a computing device (e.g., the calendar application 138 included in computing device 102a as shown in FIG. 1) can provide the pop-up reminder 352. In some implementations, the user may select or otherwise interact with the pop-up reminder 352 to obtain additional information about the availability of the content. For example, a list of movies theaters and show times for the new James Bond movie can be provided to the user in a user interface displayed on the display device 120 included in the computing device 102a. In addition or in the alternative, a computing device (e.g., the voice-based assistant application 118 included in computing device 102a as shown in FIG. 1) can provide a verbal (audio) notification that the New James Bond Movie will be released to movie theaters nationwide on Nov. 6, 2015.

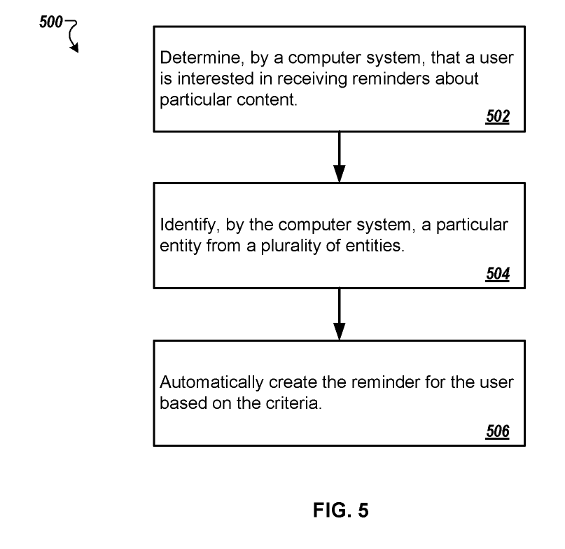

FIG. 5 is a flowchart that illustrates a method 500 for automatically creating reminders. In some implementations, the systems described herein can implement the method 500. For example, the method 500 can be described referring to FIGS. 1, 2, and 3A-C.

A computer system determines that a user is interested in receiving reminders about particular content (block 502). For example, as described herein, a computer system (e.g., the computer system 130 and specifically the content manager 150) can determine that a user is interested in receiving reminders about particular content based on intrinsic and/or extrinsic behavior of the user.

The computer system can identify a particular entity from a plurality of entities (block 504). For example, (e.g., the computer system 130 and specifically the content manager 150) can identify the entity 202a. The particular entity can be associated with the particular content and can include criteria for use in creating a reminder to the user about the availability of the particular content. For example, referring to FIG. 2, the entity 202a can include criteria for use in creating a reminder to the user about the availability of the particular content such as the context for reminder trigger 204, the offer availability type 210, the context for reminder auto-activation 206, and the reminder repeat interval 212.

The reminder for the user can be automatically created based on the criteria (block 506). The reminder can be scheduled for activation when the computing device is determined to be in proximity to a physical location that includes a device that provides the particular content to the user.

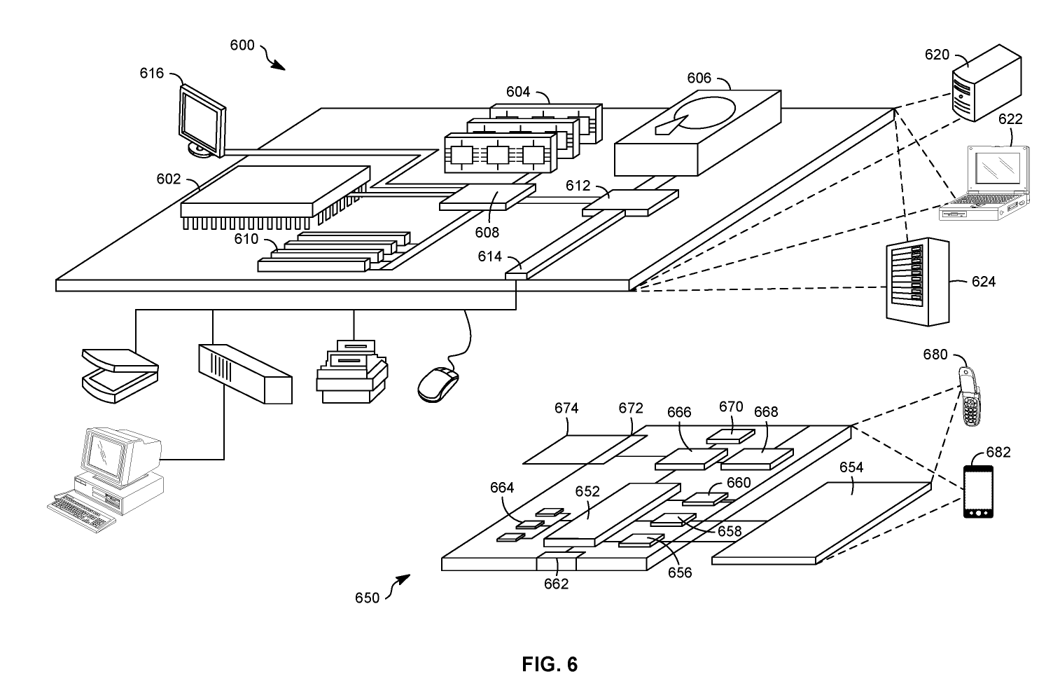

FIG. 6 shows an example of a generic computer device 600 and a generic mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In situations in which the systems and methods discussed herein collect personal information about users, or may make use of personal information, the users may be provided with an opportunity to control whether programs or features collect user information either as personally identifiable information or as anonymized information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
determining, by a computer system, that a user is interested in receiving reminders about particular content;
determining, by the computer system, that a particular entity included in a plurality of entities is associated with the particular content, the particular entity including criteria for use in creating a reminder to the user about availability of the particular content;
based on determining that the particular entity is associated with the particular content, automatically creating the reminder for the user based on the criteria; and
scheduling the reminder for activation on a computing device when the computing device is determined to be in proximity to a physical location that includes a device that provides the particular content to the user.

2. The method of claim 1, wherein determining that the user is interested in receiving reminders about particular content includes identifying an intrinsic interest of the user in the particular content.

3. The method of claim 2, wherein the intrinsic interest of the user in the particular content is based on one or more search terms entered by the user in a web browser user interface (UI).

4. The method of claim 1, wherein determining that the user is interested in receiving reminders about particular content includes determining that the user manually defined one or more contexts in which to create the reminder.

5. The method of claim 1, wherein the criteria for use in automatically creating a reminder to the user about availability of the particular content includes at least one of a time, a time window, timeframe, and a repeat interval.

6. The method of claim 1, wherein the particular content is one of a movie, a TV show, a TV episode, a TV season, a streaming media video clip, a video clip pertaining to a particular TV show, or a video clip pertaining to a particular movie.

7. A computing system comprising:
one or more processors configured to execute a content manager including a data model and a content reminder module, the data model including a plurality of entities, each entity included in the plurality of entities including criteria for use in creating reminders associated with content; and
a repository including the content,
the content manager being configured to:
determine that a particular content included in the content is associated with at least one particular entity included in the plurality of entities; and
determine that a user is interested in receiving at least one reminder about availability of the particular content, and
the content reminder module being configured to, based on determining, by the content manager, that the particular content is associated with the at least one particular entity:
automatically create a reminder for the user based on the criteria; and
automatically schedule the reminder for activation on a computing device when the computing device is determined to be in proximity to a physical location that includes a device that provides the particular content to the user.

8. The computing system of claim 7, wherein the content manager further includes a reminder provider module configured to provide a user experience on the computing device for receiving and engaging with the at least one reminder about the availability of the particular content.

9. The computing system of claim 7, wherein the at least one particular entity includes a context for reminder trigger specifying the physical location.

10. The computing system of claim 7, wherein the content manager further includes an offer availability type that specifies at least one platform for delivery of the particular content.

11. The computing system of claim 7, wherein the at least one particular entity includes a type of user interest indicating that the particular content associated with the particular entity is either of implicit interest to the user or of explicit interest to the user.

12. The computing system of claim 7, wherein the particular content is one of a movie, a TV show, a TV episode, a TV season, a streaming media video clip, a video clip pertaining to a particular TV show, or a video clip pertaining to a particular movie.

13. The computing system of claim 7, wherein the content manager interfaces with at least one of a search engine, a voice-based assistant, and a calendar application.

14. A method for managing content, the method comprising:
receiving, at a first time and by a computing device executing a search engine application, one or more search terms indicative of particular content of interest to a user;
identifying additional content related to the particular content based on the one or more search terms;
determining that the additional content is available for access by the user at a second time later than the first time;
providing, to a computer system, information indicative of an interest of the user to receive reminders about the particular content, the computer system creating a reminder for the user based on the one or more search terms being indicative of the particular content of interest to the user and based on the user not accessing the additional content at the first time, the reminder being scheduled to trigger at the second time;
receiving, by the computer device, the reminder indicating that the additional content related to the particular content is available for access by the user at the second time; and
providing, by the computing device, a user experience for engaging with the reminder when the reminder triggers at the second time.

15. The method of claim 14, wherein receiving, by the computer device and at the second time, the reminder indicating that the additional content related to the particular content is available for access by the user includes receiving the reminder by at least one of a search engine, a voice-based assistant, and a calendar application.

16. The method of claim 14, wherein the content is one of a movie, a TV show, a TV episode, a TV season, a streaming media video clip, a video clip pertaining to a particular TV show, or a video clip pertaining to a particular movie.

17. The method of claim 14,
wherein the reminder further includes information relevant to the user when accessing the available content; and
wherein the user experience for engaging with the reminder includes interacting, by the user, with the information relevant to the user.

18. A non-transitory, machine-readable medium having instructions stored thereon, the instructions, when executed by a processor, cause a computing device to:
execute a search engine application;
receive, at a first time and in a graphical user interface of the search engine application, one or more search terms indicative of particular content of interest to a user;
identify additional content related to the particular content based on the one or more search terms;
determine that the additional content is available for access by the user at a second time later than the first time;
provide, to a computer system, information indicative of an interest of the user to receive reminders about the particular content, the computer system creating a reminder for the user based on the one or more search terms indicative of the particular content of interest to the user and based on the user not accessing the additional content at the first time, the reminder being scheduled for the second time;
receive, at the second time, the reminder indicating that the additional content related to the particular content is available for access by the user; and
provide, by the computing device, a user experience for engaging with the content reminder.

19. The non-transitory, machine-readable medium of claim 18, wherein receiving, by the computer device and at the second time, the reminder indicating that the additional content related to the particular content is available for access by the user includes receiving the reminder by at least one of a search engine, a voice-based assistant, and a calendar application.

20. The non-transitory, machine-readable medium of claim 18,
wherein the reminder further includes information relevant to the user when accessing the available content; and
wherein the user experience for engaging with the content reminder includes interacting, by the user, with the information relevant to the user.
